(19) United States
(12) Patent Application Publication
(10) Pub. No.: US 2008/0214769 A1
(43) Pub. Date: Sep. 4, 2008

(54) Polyurethanes with an Asker C-Hardness of Between 1 and 70

(75) Inventors: Wolfgang Pohl, Munchen (DE); Stefan Quaiser, Danne (DE); Gheun-Gwo Chen, Taipe (TW); Wei Liang Chien, Hsing Chu City (TW)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/718,936

(22) PCT Filed: Nov. 4, 2005
(86) PCT No.: PCT/EP05/11817

§ 371 Date: May 9, 2007

(30) Foreign Application Priority Data
Nov. 10, 2004 (DE) 10 2004 054 394.1

(51) Int. Cl. C08G 18/08; C08G 18/28

(52) U.S. Cl. 528/44

(57) ABSTRACT

Process for preparing polyurethanes having an Asker C hardness of from 1 to 70 by reacting (a) isocyanates with (b) compounds which are reactive toward isocyanates, wherein (b1) monools which have a molecular weight in the range from 1500 g/mol to 6000 g/mol and are based on monoalcohols having from 2 to 6 carbon atoms which have been alkoxylated by means of ethylene oxide and/or propylene oxide are used as (b) compounds which are reactive toward isocyanates.

The invention relates to a process for preparing polyurethanes, preferably polyurethane elastomers, particularly preferably compact polyurethane elastomers, which have an Asker C hardness of from 1 to 70, preferably from 5 to 25, and preferably contain no customary plasticizers by reacting (a) isocyanates with (b) compounds which are reactive toward isocyanates. Furthermore, the invention relates to polyurethanes having an Asker C hardness of from 1 to 70, preferably from 5 to 25, which can be obtained in this way and also products, in particular moldings for shoes, bicycle saddles or moldings for orthopedic technology comprising these polyurethanes according to the invention.

Polyisocyanate polyaddition products, e.g. polyurethanes which may comprise polyisocyanurate and/or polyurea structures, are generally known,

Polyurethanes containing liquid plasticizers are known in the production of pliable moldings having an Asker C hardness of less than 70, e.g. for insoles or as soft-feel computer keyboards, The plasticizers are usually required both for setting the desired hardness and as diluents for the generally highly viscous polyester polyols. However, the use of plasticizers is undesirable because of their migration properties. In addition, the known solutions have the disadvantage that the moldings tend to be very sticky on the surface, in particular in the case of reaction systems which require a relatively long reaction time for curing.

DE-A 101 38 132 discloses the preparation of polyurethane gels which are prepared using fatty acid compounds having at least 2 hydroxyl groups and, if appropriate, short-chain alkoxylated fatty acids.

It was an object of the present invention to develop a process for preparing polyurethanes, preferably a polyurethane gel, which have an Asker C hardness of from 1 to 70, preferably from 5 to 25, and preferably contain no customary plasticizers and are only slightly sticky and virtually odor-free, in which the softness can be achieved without use of plasticizers, have a pleasant touch, are washable and when used as pressure sensitive adhesive can easily be removed from the substrate. This object has been able to be achieved by using (b1) monools which have a molecular weight in the range from 1500 g/mol to 6000 g/mol, preferably from 1900 g/mol to 4000 g/mol, and are based on monoalcohols having from 2 to 6 carbon atoms, preferably from three to five carbon atoms, which have been alkoxylated by means of ethylene oxide and/or propylene oxide, preferably ethylene oxide and propylene oxide, as (b) compounds which are reactive toward isocyanates.

The polyols (b1) used according to the invention can be prepared by generally known alkoxylation of generally known, monofunctional starter substances, for example by base-catalyzed molecular addition of lower alkylene oxides, in particular ethylene oxide and/or propylene oxide. Possible starter substances are, for example, monoalcohols, preferably ethanol, 1-propanol, 2-propanol, 1-butanol, 2-butanol, 1-pentanol, 2-pentanol, 3-pentanol, 1-hexanol, particularly preferably 1-butanol.

The weight ratio of ethylene oxide to propylene oxide in the monool (b1) is preferably from 20:80 to 80:20, particularly preferably from 40:60 to 60:40, with the different alkyene oxides being able to be arranged in blocks and/or randomly,

Particular preference is given to (b1) being based on 1-butanol which has been alkoxylated, preferably randomly, by means of ethylene oxide and propylene oxide.

The polyurethane gels of the invention are preferably used in plasticizer-free components such as mouse pads, bicycle saddles, insoles various handles or grips.

Apart from the applications mentioned, the polyurethanes of the invention are also suitable for producing elastic computer keyboards or consumer art ices of a similar type and also in the fields of intensive-care medicine, e.g. for the production of special beds, or vehicle technology where very pliable moldings are required. Particular preference is given to moldings having this low hardness for applications in the shoe and othopedics sector. Thus, very soft to gel-like insoles which have particularly favorable support properties can be produced using the pliable PUR cast resin system. In orthopedics, the novel property of the PUR cast resin system of the invention is particularly advantageous. Thus, the cured novel system or the finished moldings has gas solvent properties under pressure. Thus, very soft to gel-like insoles can be produced using the polyurethanes of the invention, with the starting components being able to be loaded with (a) gas, e.g. air or nitrogen, for preparing the polyurethanes This loading with air can be carried out by generally known methods using customary machines, for example high-pressure machines. When such a sole provided with microbubbles is used in the shoe, an imprint of the pressure lading and pressure distribution is obtained after he shoe has been worn for a certain time, since the gas in the microbubbles dissolves in the region of pressure loading and the sole becomes transluscent to clear in these places. Accordingly, the polyurethanes of the invention, in particular shoe components and in particular shoe soles, which have gas bubbles, preferably air bubbles, having a diameter of from 5 to 500 mm in the polyurethane are also preferred according to the invention. Preference is given according to the invention to polyurethanes which have a compact structure or, owing to loading with gases, have gas bubbles having the abovementioned diameter, particularly preferably compact polyurethanes.

These products, in particular bicycle saddles, moldings for the shoe and orthopedic sectors, comprising the polyurethanes of the invention are thus likewise provided by the present invention.

Particular preference is also given to adhesive elements, in particular pressure sensitive and adhesive strips, comprising the polyurethanes of the invention.

The production of the polyurethanes of the invention can be carried out by generally known methods, in particular methods which are known for cast resin systems, for example by mixing the starting components and curing of the reaction mixture in appropriate molds. The processing to form the shaped part can in the simplest case be carried out by manual mixing of the components. However, preference is given to machine processing which can be carried out either by means of a low-pressure polyurethane processing machine or by means of a high-pressure polyurethane processing machine. Under the latter processing conditions, the starting components according to the invention can be processed without problems at component temperatures of up to 90° C. and pressures of up to 200 bar.

The production of polyurethanes, usually on the basis of (a) isocyanates and (b) compounds which are reactive toward isocyanates and, if appropriate, (C) catalysts, (d) blowing agents, (e) gases and/or (f) auxiliaries, is generally known and has been described widely.

The following details regarding the starting components nay be provided:

As (a) isocyanates, preferably organic diisocyanates and/or polyisocyanates, it is possible to use the aliphatic, cycloaliphatic, araliphatic and preferably aromatic polyfunctional isocyanates known per se. Specific examples are: alkylene diisocyanates having from 4 to 12 carbon atoms in the alkylene radical, e.g. dodecane 1,12-diisocyanate,2-ethyltetramethylene-1,4-diisocyanate, 2-methylpentamethylene 1,5-diisocyanate, tetramethylene 1,4-diisocyanate and preferably hexamethylene 1,6-diisocyanate; cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate), hexahydrotolylene 2,4- and 2,6-diisocyanate and also the corresponding isomer mixtures, dicyclohexylmethane 4,4′-2,2′- and 2,4′-diisocyanate and also the corresponding isomer mixtures, and preferably aromatic diisocyanates and polyisocyanates such as tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of their mixtures. Use is frequently also made of modified polyfunctional isocyanates, i.e. products obtained by chemical reaction of organic diisocyanates and/or polyisocyanates. Examples which may be mentioned are diisocyanates and/or polyisocyanates containing ester, urea, biuret, allophanate, carbodiimide, isocyanurate, uretdione and/or urethane groups. Specific examples are: organic, preferably aromatic polyisocyanates containing urethane groups and having NCO contents of from 33.6 to 15% by weight, preferably from 31 to 21% by weight, based on the total weight, for example diphenylmethane 4,4′-diisocyanate modified with low molecular weight diols, triols, dialkylene glycols, trialkylene glycols or polyoxyalkylene glycols having molecular weights up to 6000, in particular molecular weights up to 1500, modified diphenylmethane 4,4′- and 2,4′-diisocyanate mixtures or modified crude MDI or tolylene 2,4- or 2,6-diisocyanate, with examples of dialkylene glycols or polyoxyalkylene glycols which can be used individually or as mixtures, being: diethylene glycol, dipropylene glycol, polyoxyethylene, polyoxypropylene and polyoxypropylene-polyoxyethylene glycols, triols and/or tetrols. Also suitable are prepolymers which contain NCO groups and have NCO contents of from 25 to 3.5% by weight, preferably from 21 to 14% by weight, based on the total weight, and are prepared from the polyester polyols and/or preferably polyether polyols described below and diphenylmethane 4,4′-diisocyanate, mixtures of diphenylmethane 2,4′- and 4,4′-diisocyanate, tolylene 2,4- and/or 2,6-diisocyanates or crude MD. Further isocyanates which have been found to be useful are liquid polyisocyanates containing carbodiimide groups and/or isocyanurate rings and having NCO contents of from 33.6 to 1% by weight, preferably from 31 to 21% by weight, based on the total weight, e.g. ones based on diphenylmethane 4,4′-, 2,4′-and/or 2,2′-diisocyanate and/or tolylene 2,4- and/or 2,6-diisocyanate. The modified polyisocyanates can, if appropriate, be mixed with one another with unmodified organic polyisocyanates such as diphenylmethane 2,4′-, 4,4′-diisocyanate, crude MDI, tolylene 2,4- and/or 2,6-diisocyanate. Organic polyisocyanates which have been found to be particularly useful and are therefore preferably employed are: mixtures of tolylene diisocyanates and crude MDI or mixtures of modified organic polyisocyanates containing urethane groups, in particular those based on tolylene diisocyanates, diphenylmethane 4,4′-diisocyanate, diphenylmethane diisocyanate isomer mixtures or crude MDI, in particular crude MDI having a diphenylmethane diisocyanate isomer content of from 30 to 80% by weight, preferably from 30 to 55% by weight. Preference is given to using a urethane-modified isocyanate which has an NCO content of less than 15%, particularly preferably a urethane-modified isocyanate which is the reaction product of an isocyanate with a polyether diol having a molecular weight of at least 1000 g/mol, preferably from 2000 to 6000 g/mol, particularly preferably with a mixture of a bifunctional polyether polyol based on propylene glycol, propylene oxide and ethylene oxide and having a molecular weight of greater than 2000 g/mol and a polypropylene glycol having a molecular weight of greater than 1000 g/mol, as (a) isocyanates.

Particular preference is given to using a prepolymer which bears isocyanate groups and is based on the reaction of isocyanates, preferably diisocyanates, with monools (b1i) which have a molecular weight in the range from 1500 g/mol to 6000 g/mol, preferably from 1900 g/mol to 5000 g/mol, particularly preferably from 3000 g/mol to 4500 g/mol, and are based on monoalcohols having from 2 to 6 carbon atoms which have been alkoxylated by means of ethylene oxide and/or propylene oxide as isocyanate (a). The prepolymer bearing isocyanate groups is very particularly preferably based on the reaction of isocyanates, preferably diisocyanates, with monools (b1i) which have a molecular weight of from 1500 g/mol to 6000 g/mol, preferably from 1900 g/mol to 5000 g/mol, particularly preferably from 3000 g/mol to 4500 g/mol, and are based on monoalcohols having from 2 to 6 carbon atoms which have been alkoxylated by means of ethylene oxide and/or propylene oxide and also in addition to (b1i) at least one compound (bi), preferably polyether alcohol, which is reactive toward isocyanates and has a functionality toward isocyanates of at least two, preferably from 2 to 4, particularly preferably 2 or 3, in particular 2, and a molecular weight in the range from 1500 to 8000 g/mol, The proportion by weight of (b1i) in (bi) is from 10% by weight to 80% by weight, based on the total weight of (bi) including (b1i). The compounds (b1) presented at the outset can be used as (b1i). As compounds (bi), it is possible to use the compounds (b) described in this text. The distinction in the labeling between (b1i) and (b1) and between (b) and (bi) is made merely to relate the preferred quantities of the components (b1) and (b) separately to the polyol component (b) or the isocyanate component (a), respectively.

In addition to the monools (b1) used according to the invention, it is possible to use further isocyanate-reactive compounds (b) which have at least two reactive hydrogen atoms, advantageously compounds having a functionality of from 2 to 8, preferably from 2 to 6, and a molecular weight of from 500 to 9000 g/mol. Compounds of this type which have been found to be useful are, for example, polyetherpolyamines and/or preferably polyols selected from the group consisting of polyether polyols, polyester polyols, polythioether polyols, hydroxyl-containing polyesteramides, hydroxyl-containing polyacetals and hydroxyl-containing aliphatic polycarbonates and mixtures of at least two of the polyols mentioned. Preference is given to using polyester polyols and/or polyether polyols. The polyetherols are usually prepared by addition of lower alkylene oxides, in particular ethylene oxide and/or propylene oxide, onto starter substances having a functionality of from 2 to 8, in particular from 2 to 6. Suitable polyester polyols can be prepared, for example, from organic dicarboxylic acids having from 2 to 12 carbon atoms, preferably aliphatic dicarboxylic acids having from 4 to 6 carbon atoms, and polyhydric alcohols, preferably diols having from 2 to 12 carbon atoms, preferably 2 to 6 carbon atoms. Possible dicarboxylic acids are, for example: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used either individually or in admixture with one another. In place of the free dicarboxylic acids, it is also possible to use the corresponding dicarboxylic acid derivatives, e.g. dicarboxylic monoesters and diesters of alcohols having from 1 to 4 carbon atoms or dicarboxylic anhydrides. Preference is given to using dicarboxylic acid mixtures of succinic, glutaric and adipic acids in weight ratios of, for example, 20-35:35-50:20-32, and in particular adipic acid, Examples of dihydric and polyhydric alcohols, in particular alkanediols and dialkylene glycols, are: ethanediol, diethylene glycol, 1,2- or 1,3-propanediol, dipropylene glycol, 1,4-butanediol, 1,5-pentanediol, 1,6-hexanediol, 1,10-decanediol, glycerol and trimethylolopropane. Preference is given to using ethanediol, diethylene glycol, 1,4-butanediol, 1,5-pentanediol, 1,6-hexanediol or mixtures of at least two of the diols mentioned, in particular mixtures of 1,4-butanediol, 1,5-pentanediol and 1,6-hexanediol. It is also possible to use polyester polyols derived from lactones, e.g. ε-caprolactone, or hydroxycarboxylic acids, e.g. Ω-hydroxycaproic acid. The polyester polyols preferably have a functionality of from 2 to 4, in particular from 2 to 3, and a molecular weight of from 500 to 3000 g/mol, preferably from 1200 to 3000 g/mol and in particular from 1800 to 2500 g/mol. The molecular weights indicated in this text are the number average molecular weights in [g/mol]. Preference is given to using at least one isocyanate-reactive compound (b), preferably a polyether alcohol, which has a functionality toward isocyanates of at least 2, preferably from 2 to 4, particularly preferably 2 or , in particular 2, and a molecular weight in the range from 1500 to 8000 g/mol, preferably from 1900 g/mol to 4000 g/mol, in addition to (b1). The proportion by weight of (b1) in (b) is in this case preferably from 10% by weight to 80% by weight, based on the total weight of (b) including (b1).

It is also possible to use further diols and/or triols having molecular weights of less than 499 g/mol, preferably from 60 to 300 g/mol, as (b). Suitable compounds of this type are, for example, aliphatic, cycloaliphatic and/or araliphatic diols having from 2 to 14, preferably from 4 to 10, carbon atoms, e.g. ethylene glycol, 1,3-propanediol, 1,10-decanediol, o-, m-, p-dihydroxycyclohexane, diethylene glycol, dipropylene glycol and preferably 1,4-butanediol, 1,6-hexanediol and bis(2-hydroxyethyl)hydroquinone, triols such as 1,2,4-, 1,3,5-trihydroxcyclohexane, glycerol and trimethylolpropane and low molecular weight hydroxyl-containing polyalkylene oxides based on ethylene oxide and/or 1,2-propylene oxide and the abovementioned diols and/or triols as starter molecules.

As catalysts (c) for producing the polyurethanes, it is possible to use, in particular, compounds which strongly accelerate the reaction of the compounds containing reactive hydrogen atoms, in particular hydroxyl groups, with the organic, optionally modified polyisocyanates. Possible catalysts are organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate. The organic metal compounds are used alone or preferably in combination with strongly basic amines. Amines which may be mentioned are, for example, amidines such as 2,3-dimethyl-3,4,5,6-tetrahydropyrimidine, tertiary amines such as triethylamine, tributylamine, dimethylbenzyiamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, bis(dimethylaminoethyl) ether, bis(dimethylaminopropyl)urea, dimethylpiperazine, 1,2-dimethylimidazole, 1-azabicyclo[3.3.0]octane and preferably 1,4-diazabicyclo[2.2.2]-octane, and alkanolamine compounds such as triethanolamine, triisopropanolamine, N-methyldiethanolamine and N-ethyldiethanolamine and dimethylethanolamine. Further suitable catalysts are: tris(dialkylaminoalkyl)-s-hexahydrotriazines, in particular tris(N,N-dimethylaminopropyl)-s-hexahydrotriazine, tetraalkylammonium hydroxides such as tetramethylammonium hydroxide, alkali metal hydroxides such as sodium hydroxide and alkali metal alkoxides such as sodium methoxide and potassium isopropoxide, and also alkali metal salts of long-chain fatty acids having from 10 to 20 carbon atoms and possibly lateral OH groups. Preference is given to using from 0.001 to 5% by weight, in particular from 0.05 to 2% by weight, of catalyst or catalyst combination, based on the weight of the polyol component.

As blowing agents (d) for the polyurethane systems employed, it is possible to use the blowing agents customary for the production of polyurethane foams, for example halogenated alkanes. Low-boiling aliphatic hydrocarbons, preferably cyclopentane, n-pentane and/or isopentane, in particular n-pentane, are advantageously used as physical blowing agents. It is advantageous to use the aliphatic hydrocarbons together with water as blowing agent. The amount of aliphatic hydrocarbons used is, for example, from 2 to 25% by weight, preferably from 10 to 13% by weight, based on the polyol component. The proportion of water depends on the desired properties of the polyurethane. Preference is given to using no blowing agent.

If appropriate, auxiliaries f) can also be incorporated into the polyurethane system. Examples which may be mentioned are surface-active substances, cell regulators, fillers, dyes, pigments, flame retardants, hydrolysis inhibitors, fungistatic and bacteriostatic substances.

The invention is illustrated by the following examples:

| | [% by weight] |
|---|---|
| Polyol component | |
| Polyol 1: | 1.00 |
| Polyol 2: | 40.65 |
| Monool 1: | 58.00 |
| Coscat ® 83) | 0.35 |
| Isocyanate component | |
| Polyol 3: | 23.08 |
| Monool 2: | 38.46 |
| 4,4′-MDI, 2,4′-MDI (1:1) | 38.46 |
| Mixing Ratio: Component | A/B = 100/20 − 30 |

Polyol 1: Polyether polyol having a functionality of 4 and a molecular weight of 300 g/mol, initiated by means of ethylenediamine and propoxylated with PO;
Polyol 2: Polyether polyol having a nominal functionality of 3 and a molecular weight of 5000 g/mol, initiated by means of glycerol and propoxylated with PO and end-capped with 13.3% of EO
Polyol 3: Polyether polyol having a functionality of 3 and a molecular weight of 3000 g/mol, initiated by means of glycerol and propoxylated and ethoxylated with PO/EO (95.4:4.6) and end-capped with 5.8% of EO
Coscat ® 83: Bismuth trisneodecanoate (58%) in 42% of neodecanoic acid, procured from Caschem
Monool 1: Polyetherol having a molecular weight of 2000 g/mol and based on 1-butanol and ethylene oxide and propylene oxide in a ratio of 1:1 with random distribution;
Monool 2: Polyetherol having a molecular weight of 3850 g/mol and based on 1-butanol and ethylene oxide and propylene oxide in a ratio of 1:1 with random distribution

The product had the advantages presented at the outset (slightly sticky, virtually odorless, softness without use of plasticizers, pleasant touch, washable and when used as pressure sensitive adhesive is easy to remove from the substrate) has an Asker C hardness of about 5-10, has a high elongation (250%) is reversibly deformable and sticks to substrates of many different types (e.g. wood, glass, metals, most plastics) from which it can be pulled off again without being destroyed. The tensile strength is 0.06 N/mm², and the tear propagation resistance is 0.13 N/mm² .

1. A process for preparing polyurethanes having an Asker C hardness of from 1 to 70 by reacting (a) isocyanates with (b) compounds which are reactive toward isocyanates, wherein (b1) monools which have a molecular weight in the range from 1500 /mol to 6000 g/mol and are based on monoalcohols having from 2 to 6 carbon atoms which have been alkoxylated by means of ethylene oxide and/or propylene oxide are used as (b) compounds which are reactive toward isocyanates.

2. The process according to claim 1, wherein the weight ratio of ethylene oxide to propylene oxide is from 20:80 to 80:20, with the different alkylene oxides being able to be arranged in blocks and/or randomly.

3. The process according to claim 1, wherein (b1) is based on 1-butanol which has been alkoxylated by means of ethylene oxide and propylene oxide.

4. The process according to claim 1, wherein at least one compound (b) which is reactive toward isocyanates and has a functionality toward isocyanates of at least two and a molecular weight in the range from 1500 to 8000 g/mol is used in addition to (b1)

5. The process according to claim 4, wherein the proportion by weight of (b1) in (b) is from 10% by weight to 80% by weight, based on the total weight of (b) including (b1).

6. The process according to claim 1, wherein a prepolymer which bears isocyanate groups and is based on the reaction of isocyanates, with monools (b1i) which have a molecular weight in the range from 1500 g/mol to 6000 g/mol and are based on monoalcohols having from 2 to 6 carbon atoms which have been alkoxylated by means of ethylene oxide and/or propylene oxide, is used as isocyanate (a).

7. The process according to claim 6, wherein the prepolymer bearing isocyanate groups is based on the reaction of isocyanates, with monools (b1i) which have a molecular weight in the range from 1500 g/mol to 6000 g/mol and are based monoalcohols having from 2 to 6 carbon atoms which have been alkoxylated by means of ethylene oxide and/or propylene oxide and also, in addition to (b1i) at least one compound (bi) which is reactive toward isocyanates and has a functionality toward isocyanates of at least two and a molecular weight in the range from 1500 to 8000 g/mol.

8. The process according to claim 7, wherein the proportion by weight of (b1i) in (bi) is from 10% by weight to 80% by weight, based on the total weight of (bi) including (b1i).

9. A polyurethane obtainable by a process according to claim 1.
